(19) United States
(12) Patent Application Publication
(10) Pub. No.: US 2011/0317330 A1
(43) Pub. Date: Dec. 29, 2011

(54) ELECTROLYTE SOLUTION COMPOSITION AND ENERGY STORAGE DEVICE WITH THE SAME

(75) Inventors: Hak Kwan KIM, Gyeonggi-do (KR); Bae Kyun Kim, Gyeonggi-do (KR); Jun Hee Bae, Gyeonggi-do (KR); Dong Hyeok Choi, Gyeonggi-do (KR)

(73) Assignee: SAMSUNG ELECTRO-MECHANICS CO., LTD.

(21) Appl. No.: 12/902,719

(22) Filed: Oct. 12, 2010

(30) Foreign Application Priority Data
Jun. 28, 2010 (KR) 10-2010-0061134

(51) Int. Cl. H01G 9/038; H01G 9/022

(52) U.S. Cl. 361/502; 252/62.2

(57) ABSTRACT

Disclosed is an electrolyte solution composition including: a lithium salt including lithium ions; a non-lithium salt for reducing an amount of the lithium salt to be hydrolyzed; and a solvent for dissolving the lithium salt and the non-lithium salt.

### CROSS-REFERENCE TO RELATED APPLICATIONS

This application claims the benefit of Korean Patent Application No. 10-2010-0061134 filed with the Korea Intellectual Property Office on Jun. 28, 2010, the disclosure of which is incorporated herein by reference.

### BACKGROUND OF THE INVENTION

1. Field of the Invention

The present invention relates to an electrolyte solution composition and an energy storage device with the same; and, more particularly, to an electrolyte solution composition and an energy storage device having the electrolyte solution composition which can increase a lifetime and a capacitance of the energy storage device.

2. Description of the Related Art

Of the energy storage devices, a super-capacitor has been spotlighted as a next-generation energy storage device due to a high charge/discharge speed, a superior stability, and an environment-friendly characteristic. A conventional super-capacitor includes porous electrodes, current collectors, separation films, electrolyte, and so on. The operation of conventional super-capacitor is made by using an electrochemical reaction mechanism in which when a voltage is applied to the porous electrodes, ions within electrolyte solution composition are absorbed selectively on surfaces of the porous electrodes. In more particular, currently, the representative super-capacitors include an Electric Double Layer Capacitor (EDLC), a pseudo-capacitor, a hybrid capacitor, and so on. Among these capacitors, the EDLC is a super-capacitor which includes electrodes made of activated carbon and employs a double layer charging as a reaction mechanism. The pseudo-capacitor includes electrodes made of transition metal oxide or conductive polymer, and employs a pseudo-capacitance as a reaction mechanism. And, the hybrid capacitor is a compromise between the EDLC and the electrolytic capacitor.

Herein, the electrolyte solution composition within the super-capacitor has a significant effect on a voltage range and ion's conductivity of the super-capacitor. For example, the EDLC mainly uses the electrolyte solution composition, which is made by adding non-lithium salt like TEABF4 and TEMABF4 to organic solvent like propylene carbonate and acetonitrile. However, since the EDLC is driven at a relatively low charge/discharge voltage, it requires an electrolyte solution composition with a high solution stability so as to increase a charge/discharge voltage thereof. However, the non-lithium salt like the TEABF4 and TEMABF4 has low solution stability. Due to this, there is a limitation in using the non-lithium salt as the electrolyte solution of the energy storage device which is driven at a high driving voltage. Therefore, since the non-lithium salt causes a reduction in the stability of the electrolyte solution composition, it is impossible to use the non-lithium salt as electrolyte solution of the energy storage device which is driven in a high voltage driving scheme.

For another example, a Lithium Ion Capacitor (LIC) uses a mixing liquid, made up by cyclic carbonate compound and linear carbonate compound, as electrolyte solution composition thereof. The cyclic carbonate compound may include ethylene carbonate (EC), and propylene carbonate (PC), and the linear carbonate compound may include dimethyl carbonate (DEC), ethyl methyl carbonate (EMC), and diethylene carbonate (DEC). A widely-used lithium salt of being a solute of electrolyte solution composition includes LiPF6, LiBF4, and LiCo4. The electrolyte solution composition containing lithium salts as described above has relatively high solution stability. Therefore, the electrolyte solution composition containing lithium salt is used as electrolyte solution composition of an energy storage device driven at a relatively charge/discharge voltage. However, the lithium salts are readily hydrolyzed by moisture produced during super-capacitor's manufacture. Hydrolyze of the lithium results in production of hydrofluoric acid ions (HF). The produced HF ions play a role of catalyst which decomposes solvents of the electrolyte solution composition, and become a factor of inferior characteristics of the super-capacitor, which include occurrence of electrode's corrosion, lowered capacitance, and swelling phenomenon.

### SUMMARY OF THE INVENTION

The present invention has been proposed in order to overcome the above-described problems and it is, therefore, an object of the present invention to provide an electrolyte solution composition and an energy storage device with the electrolyte solution composition which can improve a charge/discharge efficiency of the energy storage device.

The present invention also provides an electrolyte solution composition and an energy storage device with the electrolyte solution composition which can increase a capacitance.

The present invention also provides an electrolyte solution composition and an energy storage device with the electrolyte solution composition, which is insensitive to hydrolysis and has solution stability even at a high driving voltage.

In accordance with other aspect of the present invention to achieve the object, there is provided an electrolyte solution composition including: a lithium salt including lithium ions; a non-lithium salt for reducing an amount of the lithium salt to be hydrolyzed; and a solvent for dissolving the lithium salt and the non-lithium salt.

The lithium salt may include at least one of LiPF6, LiBF4, LiSbF6, LiAsF5, LiClO4, LiN, CF3SO3, and LiC.

The non-lithium salt may include at least one of tetraethyl ammonium tetrafluoroborate: TEABF4, tetraethyl methyl ammonium tetrafluoroborate: TEMABF4, ethylmethyl ammonium tetrafluoro: EMBF4, diethylmethyl ammonium tetrafluoroborate: DEMEBF4, and spirobipyrrolidinium tetrafluoroborate: SBPBF4.

The non-lithium salt may include NH4+.

The solvent may include at least one of ethylenecarbonate (EC), propylene carbonate (PC), butylene carbonate (BC), vinyl ethylene carbonate NEC), dimethyl carbonate (DMC), methyl ethyl carbonate (MEC), diethylene carbonate (DEC), methyl propyl carbonate (MPC), dipropyl carbonate (DPC), methyl butyl carbonate (MBC), and debutyl carbonate (DBC).

A weight ratio of the lithium salt to the non-lithium salt may be 1:1 through 1:4.

A total content of the lithium salt and the non-lithium salt may be 0.1 mol/L to 1.5 mol/L within the electrolyte solution composition.

In accordance with other aspect of the present invention to achieve the object, there is provided an energy storage device including: a case; negative and positive electrodes which are disposed within the case to be spaced apart from each other; separation films which are disposed within the case and partition the negative and positive electrodes; and an electrolyte solution composition which is injected within the case, wherein the electrolyte solution composition includes: a lithium salt including lithium ions; a non-lithium salt for reducing an amount of the lithium salt to be hydrolyzed; and a solvent for dissolving the lithium salt and the non-lithium salt.

The lithium salt may include at least one of LiPF6, LiBF4, LiSbF6, LiAsF5, LiClO4, LiN, CF3SO3, and LiC.

The non-lithium salt may include at least one of tetraethyl ammonium tetrafluoroborate: TEABF4, tetraethylmethyl ammonium tetrafluoroborate: TEMABF4, ethylmethyl ammonium tetrafluoro: EMBF4, diethylmethyl ammonium tetrafluoroborate: DEMEBF4, and spirobipyrrolidinium tetrafluoroborate: SBPBF4.

The solvent includes at least one of ethylenecarbonate (EC), propylene carbonate (PC), butylene carbonate (BC), and vinyl ethylene carbonate (VEC), dimethyl carbonate (DMC), methyl ethyl carbonate (MEC), diethylene carbonate (DEC), methyl propyl carbonate (MPC), dipropyl carbonate (DPC), methyl butyl carbonate (MBC), and debutyl carbonate (DBC).

A weight ratio of the lithium salt to the non-lithium salt may be 1:1 through 1:4.

A total content of the lithium salt and the non-lithium salt may be 0.1 mol/L to 1.5 mol/L within the electrolyte solution composition.

In accordance with other aspect of the present invention to achieve the object, there is provided an energy storage device including: a case; electrodes which are disposed within the case to be spaced apart from each other; separation films which are disposed within the case and partition the electrodes; and an electrolyte solution composition which is injected within the case, wherein the electrolyte solution composition includes: a first electrolyte salt which has a charge/discharge reaction mechanism by which occluding into and dropping off the electrodes are made; a second electrolyte salt which has a charge/discharge reaction mechanism by which absorption on and desorption from surfaces of the electrodes are made; and a solvent for dissolving the first and second electrolyte salts.

The first electrolyte salt may include Li+, and the second electrolyte salt may include NH4+.

The first electrolyte salt may include at least one of LiPF6, LiBF4, LiSbF6, LiAsF5, LiClO4, LiN, CF3SO3, and LiC, and the non-lithium salt includes at least one of tetraethyl ammonium tetrafluoroborate: TEABF4, tetraethylmethyl ammonium tetrafluoroborate: TEMABF4, ethylmethyl ammonium tetrafluoro: EMBF4, diethylmethyl ammonium tetrafluoroborate: DEMEBF4, and spirobipyrrolidinium tetrafluoroborate: SBPBF4.

The solvent may include at least one of ethylenecarbonate (EC), propylene carbonate (PC), butylene carbonate (BC), and vinyl ethylene carbonate (VEC), dimethyl carbonate (DMC), methyl ethyl carbonate (MEC), diethylene carbonate (DEC), methyl propyl carbonate (MPC), dipropyl carbonate (DPC), methyl butyl carbonate (MBC), and debutyl carbonate (DBC).

A weight ratio of the first electrolyte salt to the second electrolyte salt may be 1:1 through 1:4.

A total content of the lithium salt and the non-lithium salt may be 0.1 mol/L to 1.5 mol/L within the electrolyte solution composition.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing an energy storage device including an electrolyte solution composition according to an embodiment of the present invention;

FIG. 2 is a view showing a reaction mechanism of the energy storage device shown in FIG. 1; and

FIG. 3 is a graph showing how much capacitance the energy storage device has according to electrolyte solution compositions in accordance with the embodiment of the present invention.

### DETAILED DESCRIPTION OF THE PREFERABLE EMBODIMENTS

Hereinafter, a preferred embodiment according to the present invention will be described with to the accompanying drawings. However, this is only for illustrative example, and the present invention is not limited thereto.

In the following description of the present invention, a detailed description of known functions and configuration incorporated herein will be omitted when it may make the subject matter of the present invention rather unclear.

Terms which will be later are defined on the basis of the entire contents of the present specification. Technical idea of the present invention is decided by the scope of claims, and the following embodiment is only for illustrative means to help those skilled in the art to understand.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, an electrolyte solution composition and an energy storage device with the electrolyte solution composition of an embodiment of the present invention will be described in more detail with reference to the accompanying drawings.

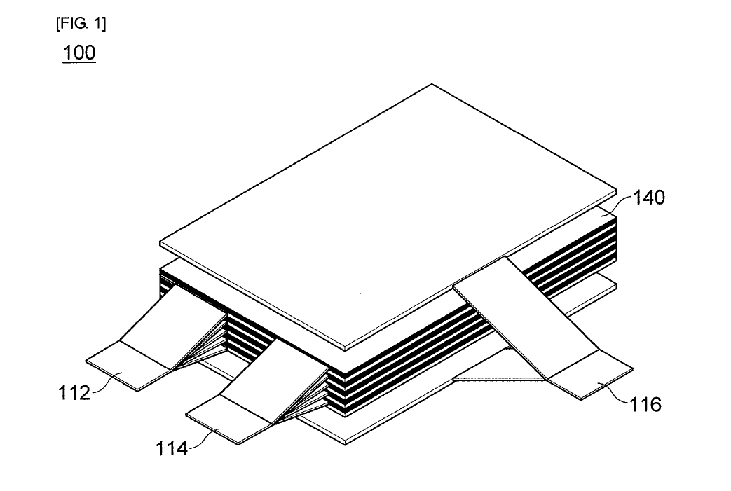

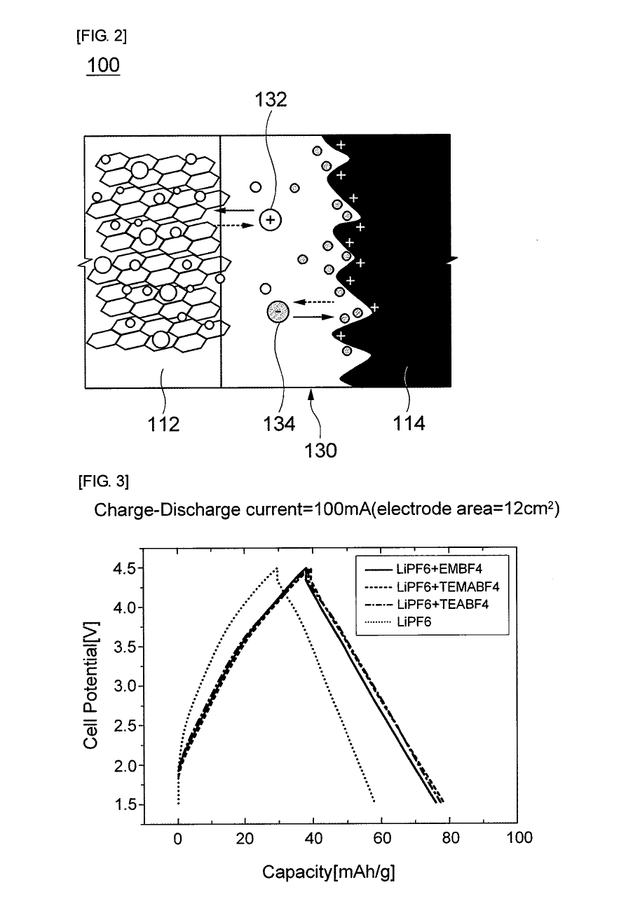

FIG. 1 is a view showing an energy storage device including an electrolyte solution composition according to an embodiment of the present invention. FIG. 2 is a view showing a reaction mechanism of the energy storage device shown in FIG. 1.

Referring to FIGS. 1 and 2, the energy storage device 100 may include an electrode structure, separation films, and an electrolyte solution composition 130.

The electrode structure 110 may include a first electrode 112, a second electrode 114, and a third electrode 116. The first to third electrodes 112 to 116 may be disposed within a case (not shown), and may be formed to be partially exposed to the outside of the case. The first and second electrodes 112 and 114 may give and take carrier ions of being a medium of an electrochemical reaction through the electrolyte solution composition 130. The first electrode 112 may be a negative electrode of the energy storage device 100. The first electrode 112 may be made of a carbon material capable of absorption and desorption of the lithium ions. For example, the first electrode 112 may be formed of graphite. The second electrode 114 may be a positive electrode of the energy storage device 100. The second electrode 114 may be an electrode made of activated carbon. And, the third electrode 116 may be a lithium electrode. The first and third electrodes 112 to 116 may be formed by being stacked in multiple layers.

The separation films 120 may be disposed selectively between the first to third electrodes 112 to 116. The separation films 120 may be interposed between the first to third electrodes 112 to 116 in such a manner to partition the first and third electrodes 112 to 116.

The electrolyte solution composition 130 may be disposed between the first electrode 112 and the second electrode 114, so as to play a role of a medium through which positive ions 132 and negative ions 134 are transferred between two electrodes. The electrolyte solution composition 130 may be one manufactured by dissolving electrolyte salt in given solvents. The electrolyte salt may include a first electrolyte salt and a second electrolyte salt. The first electrolyte salt may have positive ions 132 of a charge reaction mechanism where the positive ions are occluded into the first and second electrodes 112 and 114. The second electrolyte salt may have positive ions 132 of a charge/discharge reaction mechanism where the positive ions 132 are absorbed and desorbed on/from the surfaces of the first and second electrodes 112 and 114. As for one example, the first electrolyte salt may be lithium-based electrolyte salt, whereas the second electrolyte salt may include non-lithium based electrolyte salt.

The lithium-based electrolyte salt may be salt which includes lithium ions Li⁺ as carrier ions transferred between the first and second electrodes 112 and 114 during charge/discharge operation of the energy storage device. For example, the lithium-based electrolyte salt may include at least one of LiPF6, LiBF4, LiSbF6, LiAsF5, LiClO4, LiN, CF3SO3, and LiC. Also, the lithium-based electrolyte salt may include at least one of LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi. The lithium-based electrolyte salt has superior solution stability, so it may contribute much to an increase in a driving voltage used for charging/discharging of the energy storage device 100. Also, when compared with the non-lithium based electrolyte salt with a reaction mechanism by physical absorption/desorption of charges, the lithium-based electrolyte salt may contribute to an increase in capacitance and energy density of the energy storage device 100.

The non-lithium based electrolyte salt may be salt which includes non-lithium ions used as carrier ions transferred between the first and second electrodes 112 and 114 during charging/discharging of the energy storage device. For example, the non-lithium based electrolyte salt may include ammonia NH₄⁺. In more particular, the non-lithium based electrolyte salt may include at least one of tetraethyl ammonium tetrafluoroborate: TEABF4, tetraethylmethyl ammonium tetrafluoroborate: TEMABF4, ethylmethyl ammonium tetrafluoro: EMBF4, and diethylmethyl ammonium tetrafluoroborate: DEMEBF4. Also, the non-lithium based electrolyte salt may include spirobipyrrolidinium tetrafluoroborate: SBPBF4. The non-lithium based electrolyte salt may have a relatively faster charge/discharge speed than that of the lithium-based electrolyte salt, since charging and discharging of charges are achieved by physical absorption and desorption of ions on/from the electrodes' surfaces. Thus, the non-lithium based electrolyte salt may contribute to an improved charge/discharge efficiency of the energy storage device 100. Also, the non-lithium based electrolyte salt generates no phenomenon in that electrodes are shrunk and expanded by the absorption and desorption of the charges, so the energy storage device 100 including the non-lithium based electrolyte salt may have a longer lifetime than another energy storage device including lithium-based electrolyte salt alone. In addition, in case where the lithium-based electrolyte salt and the non-lithium based electrolyte salt are used together, the lithium-based electrolyte salt is used relatively less than the non-lithium based electrolyte salt, which causes a reduction in the amount of hydrolysis for the lithium-based electrolyte salt. Therefore, in the case of usage of the lithium- and non-lithium based electrolyte salts, it is possible to prevent characteristics of the energy storage device 100 from being reduced due to the lithium salt.

The solvents may include at least one of cyclic carbonate and linear carbonate. For example, the cyclic carbonate may include at least one of ethylenecarbonate (EC), propylene carbonate (PC), butylene carbonate (BC), and vinyl ethylene carbonate (VEC). The linear carbonate may include at least one of dimethyl carbonate (DMC), methyl ethyl carbonate (MEC), diethylene carbonate (DEC), methyl propyl carbonate (MPC), dipropyl carbonate (DPC), methyl butyl carbonate (MBC), and debutyl carbonate (DBC). In addition to this, there may be used various types of ether-, ester-, and amide-based solvents.

When the energy storage device 100 with the above-described structure is charged, a minus voltage is applied to the first electrode 112, and a plus voltage is applied to the second electrode 114. Thus, the positive ions 132 within the electrolyte solution composition 130 may be absorbed on the first electrode 112, and the negative ions 134 therewithin may be absorbed on the second electrode 114. Thus, the positive ions 132 may be desorbed from the first electrode 112, but the negative ions 134 may be absorbed on the second electrode 114. On the other hand, when the energy storage device 100 is discharged, the second electrode 114 and the third electrode 116 may be electrically interconnected to each other.

Herein, the positive ions 132 may include Li⁺, and NH₄⁺. Such the positive ions 132 may be used as carrier ions of a charge/discharge reaction mechanism of the energy storage device 100. Of the positive ions 132, the Li⁺ is used for a charge/discharge reaction mechanism in which the Li⁺ are occluded into the first and second electrodes 112 and 114. Therefore, the Li⁺ may contribute much to an increase in capacitance of the energy storage device 100. As another of the positive ions 132, positive ions like NH₄⁺ contained in the non-lithium based electrolyte are absorbed and desorbed on/from the surfaces of the first and second electrodes 112 and 114, so that it is possible to contribute even much to an increase in a charge/discharge speed of the energy storage device 100. In addition, there occurs no phenomenon of electrodes' shrinkage and expansion in the non-lithium based electrolyte salt, which contributes to an increase in the lifetime of the energy storage device 100. Thus, the energy storage device 100 using the lithium-based electrolyte together with the non-lithium based electrolyte may have an increased capacitance, as well as an improved charge/discharge speed and a longer lifetime.

Meanwhile, the lithium salt is readily hydrolyzed due to moistures produced during the process of manufacturing the energy storage device 100. In case where the lithium salt is subjected to hydrolysis, there are produced HF ions which may reduce the characteristics of the energy storage device 100. Therefore, in order to solve this problem, it is preferable to reduce content of the lithium salt is beneficial to a solution of the above-mentioned problem. Also, the lithium salt has a relatively high stability, so its solution stability remains unchanged even at a high charge/discharge voltage. Thus, preferably, adjustment of content of the lithium salt is made so as to prevent characteristics of the energy storage device 100 from being reduced due to the hydrolysis, under the condition where its solution stability remains unchanged. Contrary to this, in the case of the non-lithium based electrolyte salt, there occurs no hydrolysis as described above, but its solution stability is relatively low. For example, the non-lithium salt has a reduced solution stability at a charge/discharge voltage of about 4.2 V, and thus the energy storage device 100 has reduced charge/discharge characteristics. Therefore, preferably, adjustment of the content of the non-lithium salt is such made that it is possible to reduce the amount of hydrolysis of the lithium salt, under the condition where the non-lithium salt has no effect on the solution stability of lithium salt.

In consideration of the conditions, the electrolyte solution composition may be made to have advantages of both the lithium salt and the non-lithium salt, and to complementarily compensate for their disadvantages. For example, of the electrolyte solution composition 130, the lithium salt and non-lithium salt are mixed at a mole concentration almost similar to each other. Also, the lithium salt and the non-lithium salt have respective contents adjusted against each other, depending on types and applications of the energy storage device 100. For example, in case where the energy storage device 100 is used in a field where output characteristics are regarded as the most important factor, it is possibly preferable to adjust a weight ratio of the non-lithium salt to be equal to or higher than that of the lithium salt. As one example, of the electrolyte solution composition 130, the total content of the lithium salt and the non-lithium salt is adjusted to be 0.5 mol/L to 1.5 mol/L. The weight ratio of the lithium salt to the non-lithium salt may be adjusted to be roughly 1:1 through 1:4. In case where the lithium salt in the electrolyte solution composition 130 has a lower content than that of the non-lithium salt based on the above-mentioned ratio, the energy storage device 100 has a reduced capacitance. In addition, at the time of initial charging/discharging, consumption of lithium ions caused by the initial SEI film formation may result in an increase in non-reciprocal capacitance of the electrodes, and a reduction in solution stability of the energy storage device 100. On the contrary, in case where the lithium salt in the electrolyte solution composition 130 has a higher content than that of the non-lithium salt based on the above-mentioned ratio, hydrolysis of the lithium salt makes the charging/discharging characteristics of the energy storage device 100 reduced.

FIG. 3 is a graph showing how much capacitance the energy storage device has depending on various electrolyte solution compositions in accordance with the embodiment of the present invention. Referring to FIG. 3, as in the present invention, it is clear that the energy storage device having electrolyte solution composition containing the lithium salt and the non-lithium salt has a higher capacitance than that of an energy storage device containing only lithium salt. That is, as shown in FIG. 3, the super-capacitor having electrolyte solution composition constituted by mixture obtained by adding at least one of non-lithium salts (e.g., LiPF6), to lithium salt (e.g., TEABF4, TEMABF4, and ethylmethyl ammonium tetrafluoro: EMBF4) may have a higher capacitance than that of a super-capacitor having electrolyte solution composition with only lithium salt (e.g., LiPF6).

As above described, the present invention provides electrolyte solution composition 130 which includes lithium salt and the non-lithium salt adjusted to have their contents in such a manner to minimize a phenomenon of shrinkage and expansion caused by the hydrolysis of the lithium salt, so that it is possible to keep solution stability unchanged even at a high driving voltage, as well as to increase output and capacitance of the energy storage device 100. As a result, the electrolyte solution composition 130 of the present invention can perform a charge/discharge operation even at a high voltage, and increase its output and capacitance.

The energy storage device 100 of the present invention includes the electrode structure 110, separation films 120, and an electrolyte solution composition 130, so that it is possible to minimize the phenomenon of shrinkage and expansion caused by the hydrolysis of the lithium salt, as well as to maintain its solution stability even at a high voltage. The energy storage device 100 may also include the lithium salt and the non-lithium salt, which are adjusted to have contents in such a manner to increase output and capacitance of the energy storage device 100. As a result, the energy storage device 100 can perform a charge/discharge operation even at a high voltage, and have increased output and capacitance.

An electrolyte solution composition of the present invention includes lithium salt and non-lithium salt, whose content has a ratio adjusted so that the lithium salt is less sensitive to hydrolysis, so that stability can be made even at a high driving voltage, and output and capacitance of the energy storage device can be adjusted to be increased. Therefore, it is possible to perform charge/discharge operations at a high voltage of the energy storage device, as well as to increase lifetime, output, and capacitance thereof.

An energy storage device of the present invention includes electrolyte solution composition with lithium salt and non-lithium salt whose content is adjusted to have high output and capacitance, so that it is possible to keep the stability even at a high voltage, as well as to minimize problems due to the hydrolysis of the lithium salt. Therefore, the energy storage device of the present invention can perform high-voltage charge/discharge operations, and increase lifetime, output, and capacitance.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. An electrolyte solution composition comprising:
a lithium salt including lithium ions;
a non-lithium salt for reducing an amount of the lithium salt to be hydrolyzed; and
a solvent for dissolving the lithium salt and the non-lithium salt.

2. The electrolyte solution composition of claim 1, wherein the lithium salt includes at least one of LiPF6, LiBF4, LiSbF6, LiAsF5, LiClO4, LiN, CF3SO3, and LiC.

3. The electrolyte solution composition of claim 1, wherein the non-lithium salt includes at least one of tetraethyl ammonium tetrafluoroborate: TEABF4, tetraethylmethyl ammonium tetrafluoroborate: TEMABF4, ethylmethyl ammonium tetrafluoro: EMBF4, diethylmethyl ammonium tetrafluoroborate: DEMEBF4, and spirobipyrrolidinium tetrafluoroborate: SBPBF4.

4. The electrolyte solution composition of claim 1, wherein the non-lithium salt includes NH₄⁺.

5. The electrolyte solution composition of claim 1, wherein the solvent includes at least one of ethylenecarbonate (EC), propylene carbonate (PC), butylene carbonate (BC), vinyl ethylene carbonate (VEC), dimethyl carbonate (DMC), methyl ethyl carbonate (MEC), diethylene carbonate (DEC), methyl propyl carbonate (MPC), dipropyl carbonate (DPC), methyl butyl carbonate (MBC), and debutyl carbonate (DBC).

6. The electrolyte solution composition of claim 1, wherein a weight ratio of the lithium salt to the non-lithium salt is 1:1 through 1:4.

7. The electrolyte solution composition of claim 1, wherein a total content of the lithium salt and the non-lithium salt is 0.1 mol/L to 1.5 mol/L within the electrolyte solution composition.

8. An energy storage device comprising:
a case;
negative and positive electrodes which are disposed within the case to be spaced apart from each other;
separation films which are disposed within the case and partition the negative and positive electrodes; and
an electrolyte solution composition which is injected within the case,
wherein the electrolyte solution composition comprises:
a lithium salt including lithium ions;
a non-lithium salt for reducing an amount of the lithium salt to be hydrolyzed; and
a solvent for dissolving the lithium salt and the non-lithium salt.

9. The energy storage device of claim 8, wherein the lithium salt includes at least one of LiPF6, LiBF4, LiSbF6, LiAsF5, LiClO4, LiN, CF3SO3, and LiC.

10. The energy storage device of claim 8, wherein the non-lithium salt includes at least one of tetraethyl ammonium tetrafluoroborate: TEABF4, tetraethylmethyl ammonium tetrafluoroborate: TEMABF4, ethylmethyl ammonium tetrafluoro: EMBF4, diethylmethyl ammonium tetrafluoroborate: DEMEBF4, and spirobipyrrolidinium tetrafluoroborate: SBPBF4.

11. The energy storage device of claim 8, wherein the solvent includes at least one of ethylenecarbonate (EC), propylene carbonate (PC), butylene carbonate (BC), and vinyl ethylene carbonate (VEC), dimethyl carbonate (DMC), methyl ethyl carbonate (MEC), diethylene carbonate (DEC), methyl propyl carbonate (MPC), dipropyl carbonate (DPC), methyl butyl carbonate (MBC), and debutyl carbonate (DBC).

12. The energy storage device of claim 8, wherein a weight ratio of the lithium salt to the non-lithium salt is 1:1 through 1:4.

13. The energy storage device of claim 8, wherein a total content of the lithium salt and the non-lithium salt is 0.1 mol/L to 1.5 mol/L within the electrolyte solution composition.

14. An energy storage device comprising:
a case;
electrodes which are disposed within the case to be spaced apart from each other;
separation films which are disposed within the case and partition the electrodes; and
an electrolyte solution composition which is injected within the case,
wherein the electrolyte solution composition comprises:
a first electrolyte salt which has a charge/discharge reaction mechanism by which occluding into and dropping off the electrodes are made;
a second electrolyte salt which has a charge/discharge reaction mechanism by which absorption on and desorption from surfaces of the electrodes are made; and
a solvent for dissolving the first and second electrolyte salts.

15. The energy storage device of claim 14, wherein the first electrolyte salt includes Li⁺, and the second electrolyte salt includes NH₄⁺.

16. The energy storage device of claim 14, wherein the first electrolyte salt includes at least one of LiPF6, LiBF4, LiSbF6, LiAsF5, LiClO4, LiN, CF3SO3, and LiC, and the non-lithium salt includes at least one of tetraethyl ammonium tetrafluoroborate: TEABF4, tetraethylmethyl ammonium tetrafluoroborate: TEMABF4, ethylmethyl ammonium tetrafluoro: EMBF4, diethylmethyl ammonium tetrafluoroborate: DEMEBF4, and spirobipyrrolidinium tetrafluoroborate: SBPBF4.

17. The energy storage device of claim 14, wherein the solvent includes at least one of ethylenecarbonate (EC), propylene carbonate (PC), butylene carbonate (BC), and vinyl ethylene carbonate (VEC), dimethyl carbonate (DMC), methyl ethyl carbonate (MEC), diethylene carbonate (DEC), methyl propyl carbonate (MPC), dipropyl carbonate (DPC), methyl butyl carbonate (MBC), and debutyl carbonate (DBC).

18. The energy storage device of claim 14, wherein a weight ratio of the first electrolyte salt to the second electrolyte salt is 1:1 through 1:4.

19. The energy storage device of claim 14, wherein a total content of the lithium salt and the non-lithium salt is 0.1 mol/L to 1.5 mol/L within the electrolyte solution composition.
